(19) United States
(12) Patent Application Publication
(10) Pub. No.: US 2005/0203697 A1
(43) Pub. Date: Sep. 15, 2005

(54) Automatic verification of sensing devices

(76) Inventor: Michael John Dalgleish, Bicester (GB)

Correspondence Address: ARENT FOX PLLC, 1050 CONNECTICUT AVENUE, N.W., SUITE 400, WASHINGTON, DC, 20036, US

(21) Appl. No.: 10/520,279

(22) PCT Filed: Jun. 6, 2003
(86) PCT No.: PCT/GB03/02449

§ 371 Date: Jan. 25, 2005

(30) Foreign Application Priority Data
Jul. 25, 2002 (GB) 0217226.0

(51) Int. Cl. G06F 19/00

(52) U.S. Cl. 701/117; 701/119

(57) ABSTRACT

A roadside traffic monitoring system comprises a primary sensor for measuring a parameter of vehicles passing a measurement point and a secondary sensor for measuring the same parameter of vehicles as they pass the measurement point. The secondary sensor is able to measure the parameter to a higher level of accuracy than the primary sensor but only under certain predetermined conditions. The system further comprises a conditions sensor for determining when these predetermined conditions are met, enabling the secondary sensor to be used to calibrate the primary sensor.

The present invention generally relates to verification of sensing devices, and more particularly but not exclusively to the verification and calibration of road-side Traffic Monitoring Stations (TMS).

A highway operator often wishes to gather information about vehicles using the highway. The speeds and journey times of vehicles are particularly of interest. For example, the operator of a motorway from London to Bristol may wish to know the speed of individual vehicles at one or a number of locations. The instantaneous speeds of vehicles at defined locations are known as “spot speeds”. The operator may also wish to know the average travel time between London and Bristol, for example, or for sections of the route. This travel time can be estimated from the spot speeds measured at the measurement points. The methods to integrate the journey time from the spot speeds are well known and will not be described herein.

For many years data logging has been performed with simple systems comprising a sensor device for the parameter of interest connected to a data recording device. The data recording means may be configured such that data is recorded at regular intervals or upon an event (such as a vehicle passing the device).

An example of such a device is the Marksman 661 8-loop traffic counter manufactured by Golden River Traffic Ltd of Churchill Road Bicester. This device detects the passage of vehicle by means of a loop sensor, a system whereby a coil of wire, typically about 2 metres by 2 metres, is placed in the road surface and connected to an oscillator in the Marksman 661. When a vehicle passes over the coil, the phase or frequency of the oscillation is affected, and this generates a signal which thereby indicates the passage or presence of the vehicle. By counting the number of times a vehicle is detected, the Marksman 661 is able to determine the vehicle counts over a 5, 15 or 60 minute interval, according to the needs of the user. Since the machine is connectable to eight loops, one loop may be placed in each lane of eight lanes of traffic and a total 8-lane count of vehicles determined over any period.

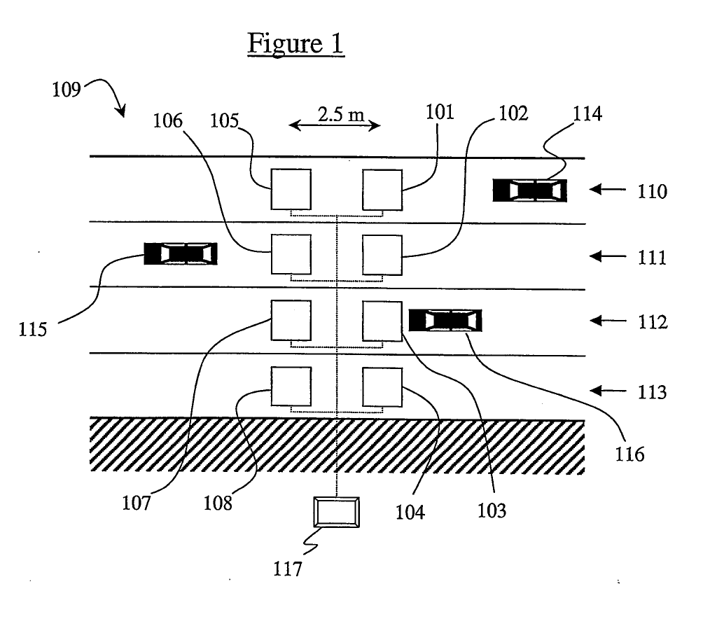

The Marksman 661 may also be connected to two loops in each lane of traffic, where such loops are 2 metres square, and spaced 2.5 metres apart in each lane of travel. A suitable arrangement is shown in FIG. 1, which shows eight loop sensors 101-108 arranged in pairs in three traffic lanes 110-112 and the hard shoulder 113 of one carriageway of a dual three lane motorway 109. Signals from the loops are transmitted via feeder cables to a central measurement and control unit 117 (the Marksman 661). As a vehicle 114 drives over the sensor in its lane 110, it is detected by two loops 101, 105 in succession. Since the distance between the loops 101, 105 is known, it is possible to calculate the speed of each vehicle 114, 115, 116, in addition to knowing its presence and the lane along which it travels.

The distinction between these two types of configuration illustrates how a data logger can record two basic types of data:
Attribute data (e.g. individual vehicle counts)
Variable data (e.g. vehicle speeds).

In practice the data logger designer will normally select the most suitable sensor based on various criteria. In the example above, the Marksman 661 was designed for use with loop sensors, because it is well known that loop sensors are very reliable, are capable of excellent results, are not affected by fog, rain sunlight etc., and are modest in cost. However, there is a possibility that roadside measurement systems employing loop sensors may drift out of calibration over time.

Another form of detector well known in the industry is the piezo detector. A piezo detector senses the passage of vehicle tyres over the sensor by the mechanical force exerted by the wheel as it passes over the sensor, which spans the width of the lane and is placed at right angles to the vehicle track. This detector has the disadvantage that when the vehicle stops moving, it stops detecting the vehicle. Piezo sensors also give a signal strength which is a function of axle weight.

Sensors are often combined in a single instrument to generate more data by the combination (known as “data fusion”) of the signals. For example, by installing two loop sensors and one piezo sensor, the dimension of the wheelbase of a vehicle may be determined by the application of the vehicle speed (derived from time of flight between the loop sensors) and the time between each successive actuation of the piezo sensor, hence enabling the system to determine the distance between each of the vehicle's axles, and to summate these to calculate the total wheelbase in the case of vehicles with more than two axles.

Another roadside speed detector in general use takes advantage of the Doppler effect. A radar source is directed towards oncoming traffic, and radio waves (or microwaves) reflected back towards the source from the moving traffic are detected. The speed of a vehicle travelling towards such a radar source can be calculated from the change in frequency of the radio waves reflected from that vehicle. Such systems are unlikely to drift out of calibration over time. However, systems with Doppler radar may be subject to installation and orientation errors that introduce the “cosine effect” whereby all speeds of vehicles are under-read by a certain proportion, determined by the angle of the radar beam relative to the vehicle direction.

Thus the application of single and multiple sensors in data logging system is well known and often deployed in highway traffic monitoring. In everyday applications such systems produce thousands of megabytes of data each day all over the world. An example of such systems is in the United States where thousands of traffic monitors collect data about vehicle class flow and vehicle weights for various applications, for example pavement design and the location of new routes. In the UK, the Private Finance Initiative has led to the payment for road maintenance by the government to private contractors based on the vehicle kilometres travelled on each link of a road during a period for payment. In this case the traffic data for “short” and “long” vehicles depends directly on vehicle counts and speeds from these automatic data loggers.

In practice, the accuracy of sensor data recorded by the data logger can be affected by a number of factors:
Normal systematic and random errors in the sensing system (not necessarily linear or other smooth functions),
The physical environment in which the sensor/detector and/or data logger operates and which may vary over time,
Minor errors of operator input/judgement, and
Major operator blunders (gross accidental or intentional errors).

Any of these errors can result in systematically biased data, or in random deviations in the data. This can lead to data which is misleading, misrepresentative or with random errors in relation to the true values. Such an effect can have a major result-on the data, leading to false payments, incorrect decisions, construction of redundant facilities etc.

The normal systematic and random errors in the sensing system may be thought to be well known. But in some cases, the situation in the field varies from that anticipated by the designer. For example, in the case of the vehicle counter, if some debris, such as a truck tyre tread which has become detached, lies in the fast lane of the motorway, then the vehicles in the fast lane will tend to avoid the debris by travelling past the site to the left or right of the normal line of travel, perhaps straddling lanes. During this period, the data will have a significantly different error profile, since the loop designer will have assumed normal travel down the centre of each lane.

It is well known that these problems occur. Therefore, particularly where financial transactions are based on data collected by roadside measurement systems, audits are performed on a regular basis to quantify the errors on this data.

Many authorities simply do not have the resources to go and check every machine for potential errors. In this case the data is accepted at face value, and carries with it the hidden cost of mistaken decisions based on data with errors. Normally a lot of small errors will cancel each other out, but as in the statistical distribution of the data, occasionally the errors will be additive, and expensive consequences can occur. For example, if the errors are positive (i.e. the data indicates a higher traffic flow than is actually the case), a facility may be built for which there is no need, or a payment may be made which is unjustified by the actual traffic flow. If the cumulative errors are negative, a facility may not be constructed at the appropriate time, causing loss of productivity to the nation, or payment may not be made when in fact it should have been.

It is obvious that in the case of publicly funded construction, or privately operated toll facilities, the disadvantage of equipment error and uncertainty about the error is a serious matter.

The most common method for determining these errors is by a manual or semi-manual process, so as to determine the performance of the sensing system. Audits are performed on a regular basis to quantify the errors. In the case of a vehicle counter, a number of enumerators are sent to site (usually a minimum of two for health and safety reasons) and a manual duplication of the process carried out.

In an enhancement of this basic process, a video recording can be made of the traffic stream from which a manual enumeration is performed afterwards, when better quality control may be possible. This adds to the cost, and typically it takes one or two enumerators 5 hours to manually enumerate 1 hour of video recording.

Another common form of validation is to compare the reported data with historic data from the same site, from the previous day, from the same day of the week the previous week, or from an average of similar days. These methods of validation are quite effective, but fail when something different really does happen, for example an accident causing a diversion on to or off the road under survey, or a carnival or other uncommon local event.

In a variant to this method, several sites may be connected to each other, and validation suspended at the times when all sites report unusual parameters. A disadvantage of this method is that communication between sites is required. Furthermore, true errors at the times when validation is suspended will not be detected.

As an alternative, an additional measurement system may be set up in the same location as a roadside measurement station, and used to measure the same parameters (e.g. the speed) of vehicles as the roadside system. This data can then be used to validate the roadside measurement station under assessment. The equipment and method for assessing measurement stations needs to be suitable for fast and efficient verification of speed monitoring equipment. This means that the system must be portable and suitable for quick deployment or assessment.

At present, systems for traffic speed measurement assessment in addition to buried loops include the following methods:
Radar (Doppler) or LIDAR (Laser Diode Ranging).
Two light beams horizontally or vertically across the carriageway.
Two pressure sensors on the road surface.

Radar devices use the Doppler effect as described above. When portable devices are used, the radio source and receiver are located in a hand held device (a “speed gun”). Such devices are very accurate when used in suitable conditions, but can still give rise to a number of drawbacks. Firstly, when a motorist sees a speed gun in use, they will often apply the brakes, or at least take their foot off the accelerator. This means that the vehicle will be slowing as it passes the sensor and this will introduce a measurement error. Furthermore, the method is very labour-intensive and difficult to use in heavy traffic. There are errors introduced by the “cosine” effect, the effect of the angle between the gun beam and the vehicle direction.

Two horizontal light beams or pressure sensors on the road surface may be used successfully in low volume single lane carriageways. However, many modern roads are dense dual carriageways, and these methods are impractical in practice across all lanes. Installing sensors on the road is hazardous and can easily lead to an accident.

At this point it is useful to point out the difference between validation and verification in the art of traffic monitoring.

Verification is a process whereby a sample of measurements from the system under assessment is compared with independently determined accepted reference values. After adjustment for sampling error, the monitoring system error rate is compared with specification and determined to pass or fail the requirements. The evidence collected should fulfil reasonably strict audit requirements as being satisfactory proof of performance.

Validation is usually a continuous process designed to detect anomalies in the data being produced by each Outstation and by the system as a whole. Whilst data lies inside validation limits, reduced verifications (say 6-monthly) may be carried out. If reported data lies outside pre-determined validation limits, for example historic values plus or minus a percentage, perhaps for more than a certain number of times, then an investigation of this ‘anomaly’ is performed. Usually an actual traffic event or other plausible explanation for the anomaly is found. If not, the equipment is repaired and/or replaced, and tightened (say 3-monthly), verifications are triggered. After a certain continuous period of validation limits being met again, reduced verifications may be reinstated.

In short, verification compares reported data with independently determined reference values. Validation compares reported data with a ‘prediction’ of what the data might be expected to be, based on historic data or some other scientific calculation.

In a semi-automatic system, British Patent Number 2377027 describes a system for verification which uses a probe vehicle as a sensing device. In this case an additional vehicle is injected into the vehicle stream, and this vehicle is essentially tracked through the facility with its speed determined by a highly accurate continuous speed reporting system. The problem with this method for the present invention is that it relies on just one vehicle, whereas for counting assessment, a sample of hundreds or thousands of vehicles is necessary. Clearly the cost to apply that technique to the current subject would be excessive and more costly than the manual methods described above.

The invention takes advantage of the fact that secondary sensors, which may use a different sensing method, may be used as a reference for a primary sensor. Errors can be determined, and the data from the instrument under assessment can be given a confidence level or interval.

In accordance with a first aspect of the present invention there is provided a roadside traffic monitoring system, comprising:
a primary sensor for detecting a parameter of vehicles passing a measurement point;
a secondary sensor for measuring the same parameter of vehicles passing the measurement point, the secondary sensor able to measure the parameter to a higher level of accuracy under predetermined conditions;
a conditions sensor for determining when the predetermined conditions are met; and verification means for comparing the parameter as measured by the primary sensor with the parameter as measured by the secondary sensor.

Synchronisation means may be provided to ensure that the parameter measurement by the primary and secondary sensors occurs at the same moment in time.

In a roadside system, the primary sensor will represent the best balance of cost and performance for the data to be sensed and recorded. In the case of the example of the Marksman M661, this primary sensor is the loop system installed in the road. The secondary sensor will preferably use a different detection system, for example a microwave Doppler detection system. Such a system is very accurate, but only if there is only one vehicle in the microwave beam and if the precise location of this vehicle relative to the microwave detector is known so that the cosine effect can be compensated for. It is therefore not suitable for use as a primary sensor, but ideal for use as a secondary sensor if it can be guaranteed that when a reading is taken there is a single vehicle in the microwave beam at a precisely defined location.

In other words, in this example, the predetermined conditions are that there is only one vehicle in the microwave beam at a known position. A suitable test for this might be that if no vehicle is detected by the primary sensor for a predetermined period of time (e.g. one second), then a single vehicle is detected, and then no vehicle is detected for a further predetermined period of time, then only a single vehicle is in the beam. The precise location of the measurement point relative to the microwave detector is easily measurable, and the secondary sensor only measures the parameter when the vehicle is at the measurement location.

The primary sensor is preferably verified by reference to a difference between the parameter as measured by the secondary sensor and the parameter as measured by the primary sensor.

The conditions sensor may be included in the primary sensor or the secondary sensor. In the example above, the loop sensor, acting as the primary sensor, determines when there is only a single vehicle in the microwave beam so the predetermined conditions are met. Alternatively, the microwave detector could determine for itself when there is only one vehicle in the beam.

The measured parameter may be vehicle density or number. In other words, the parameter for a single vehicle could be said simply to be its presence.

Preferably the roles of the primary and secondary sensors are reversible so that the primary sensor is usable to calibrate the secondary sensor. In the loop sensor/microwave Doppler sensor discussed above, it would be possible, when the system is initially installed, to use the loop sensor to measure the accuracy of the Doppler sensor. In other words, the compensation for the cosine effect could be determined experimentally by measuring the speed of a vehicle at the measurement point using a well characterised loop sensor, rather than calculating the cosine effect from the relative location of the microwave detector and the measurement point.

Either or both of the primary and secondary sensors may comprise a video detection system. Such systems may be suitable for measuring vehicle flow (count), density and/or vehicle speed.

In accordance with a second aspect of the present invention there is provided apparatus for assessing the accuracy of a roadside traffic measurement station (TMS) having a primary sensor for measuring a parameter of vehicles passing a predetermined measurement point and the moment in time at which each vehicle passes the measurement point, the apparatus comprising:
a secondary sensor arranged to record the same parameter of vehicles as they pass the predetermined measurement point, the second sensor being more accurate than the first parameter measurement means if predetermined conditions are met;
a condition measuring means for determining when said predetermined conditions are met; and
verification means for comparing the parameter as measured by the secondary sensor with the parameter as measured by the primary sensor.

In accordance with a third aspect of the present invention there is provided a method of monitoring a parameter of vehicles, comprising:
measuring the parameter of a vehicle at a measurement point using a primary sensor;
determining whether predefined conditions are met;
measuring the parameter of the vehicle at the measurement point using a secondary sensor, the secondary sensor being more accurate than the primary sensor if the predefined conditions are met; and
if the predefined conditions are met, using the difference between the parameter as measured by the secondary sensor and the parameter as measured by the primary sensor to verify the primary sensor.

When the secondary system is known to be within its operating zone, the primary system is assessed using and assuming that the data from the secondary system is completely true. This will produce a confidence interval for the data from the data logger, since the performance of the primary system is unaffected by the environmental factors which affect the secondary system. Alternatively, if the uncertainty in measurements made by the secondary sensor is known, this uncertainty is used to weight the significance of assessments of the uncertainty of the primary sensor.

As an extension to the assessment of the primary sensor system, the error data collection may be collated into a time series. Thus a “control chart” may be prepared, showing the periodic error rate as a function of time. Using the principles of statistical process control, this data may be analysed and the instrument assessed as being in or out of control.

Such a function provides a valuable management tool in assessing whether the underlying process has changed and/or whether a formal test of the measuring system is required.

It will be appreciated that the invention may apply to any system having a sensor with an uncertainty associated with it.

It will also be appreciated that a calibration function may equally well be substituted for the verification function as described above where a calibration function or output is required.

In accordance with a fourth aspect of the invention there is provided a point speed measurement system, comprising:
a Doppler-effect speed sensor; and
a vehicle detection system arranged to trigger the Doppler-effect speed sensor when a vehicle is at a predetermined measurement position, the distance and direction from the Doppler-effect speed sensor to the predetermined measurement point being known;
arranged so that the output from the Doppler-effect speed sensor is adjusted to compensate for the cosine effect at the predetermined measurement position.

It will be appreciated that the invention may apply to any system having a sensor with an uncertainty associated with it. Thus in accordance with a fifth aspect of the invention there is provided a data sensing system, comprising:
a primary sensor for measuring a parameter value;
a secondary sensor for measuring the same parameter value as the primary sensor, the secondary sensor able to measure the parameter value more reliably than the primary sensor under predetermined conditions;
synchronisation means for ensuring that the primary sensor and secondary sensor measure the parameter value at the same time; and
validation means for comparing the parameter value as measured by the primary sensor with the parameter value as measured by the secondary sensor if the predetermined conditions are met.

In accordance with a sixth aspect of the invention there is provided a method of validating a primary data sensor, comprising:
measuring a parameter with the primary sensor;
measuring the same parameter with a secondary sensor, the secondary sensor being more accurate than the primary sensor under predetermined conditions; and
comparing the parameter as measured by the primary sensor with the parameter as measured by the secondary sensor if the predetermined conditions are met.

Some preferred embodiments of the invention will now be described by way of example only and with reference to the accompanying drawings, in which:

FIG. 1 shows the components of a traffic monitoring station (TMS) having four pairs of loop sensors;

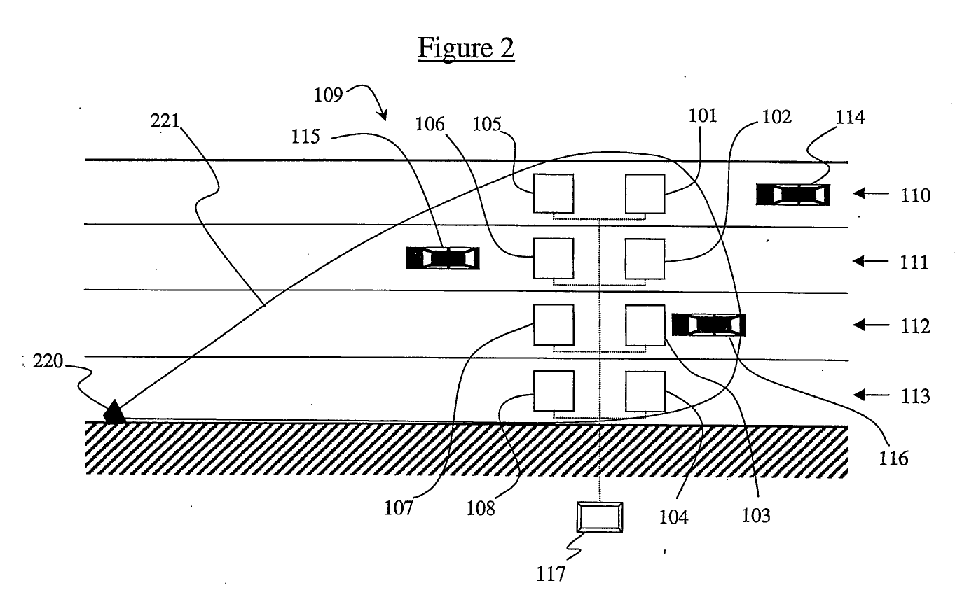

FIG. 2 shows a TMS having four pairs of loop sensors and a microwave Doppler sensor;

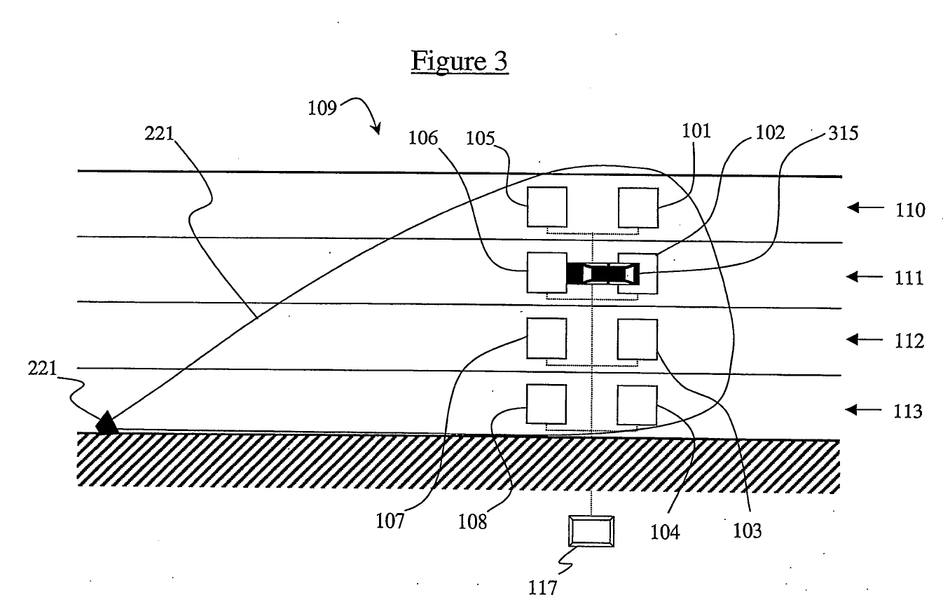

FIG. 3 shows the TMS of FIG. 2 at the moment when a reading is made by the microwave Doppler sensor;

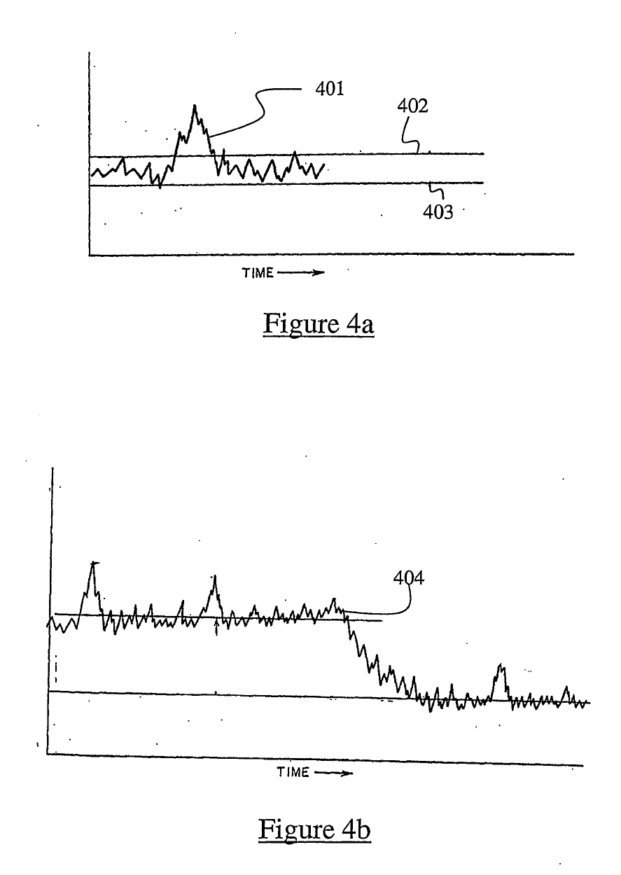

FIG. 4a is a graph showing a measurement error plotted against time; and

FIG. 4b is a graph showing a step change in an error plot.

FIG. 1 shows the components of a known traffic monitoring station (TMS), arranged to measure the speeds of vehicles 114, 115, 116 in one carriageway of a motorway 109, i.e. three lanes 110, 111, 112 of traffic and the hard shoulder 113. The measurement station comprises wire loops 101-108 located under the surface of the roadway, two loops being located under each lane of traffic 2.5 m apart. The following discussion will consider the two loops 101, 105 located in the first lane of traffic 110, but it will be appreciated that the same considerations will apply for all of the other lanes.

Each loop 101, 105 is about two metres square and consists of 3 turns of wire. As a vehicle 114 passes over the loop it causes a change in the inductance of the loop, and this can be detected by “loop detectors” attached to the loop. The loop detectors are connected to a measurement and control unit 117 (e.g. a Marksman M661) which includes processing means for analysing information passed to the measurement and control unit by the loop detectors. The loop detectors can be arranged to provide an analogue representation of the passing of each vehicle, or alternatively can be set to be switched “on” or “off” by the passage of a vehicle. Every time a vehicle 114 is detected by a loop sensor 101, 105 this information is passed to the measurement and control unit 117. The speed of a vehicle 114 passing the loops 101, 105 is determined by the measurement and control unit 117 from the time it takes between detection by the two detectors attached to the loops 101 and 105. This gives the time for the vehicle to travel 2.5 m, and thus its speed over that distance.

FIG. 2 is a schematic top view of an automatically validated traffic monitoring system having primary and secondary detection systems. A primary detection system comprises four loop sensors 101 to 108 and is essentially the same as the arrangement shown in FIG. 1.

A secondary detection system comprising a microwave Doppler sensor 220 is installed at the roadside about 30 metres upstream or downstream of the loop sensors. The Doppler sensor 220 comprises a microwave emitter which emits microwaves in a beam 221 which covers all the loop sensors 101-108. As a vehicle 116 passes through the beam, microwaves are reflected back towards the Doppler sensor 220. The frequency of the reflected microwaves is higher than the frequency of the emitted microwaves, with the increase in frequency determined by the Doppler shift caused by speed of the vehicle 116 and the direction of travel relative to the Doppler sensor 220.

In other words the Doppler sensor provides an output which is an analogue or digital stream whose frequency represents the Doppler shift of the reflected microwaves. The frequency of the signal is directly proportional to the velocity of a vehicle relative to a line from the detector to the vehicle. Such simple microwave Doppler detectors have the advantage of low price and multiple suppliers. But the beam 221 of the device shown in FIG. 2 is wide, and the simple device will only function correctly when only one vehicle is in the beam area. If there is more than one vehicle, the sensor will tend to select the biggest target at any time and lock onto that. In the situation shown in FIG. 2, three vehicles, 114, 115, 116 are in the microwave zone of detection, but none are over the loop sensors 101 to 108. The Doppler sensor 220 may lock onto one or more of the vehicles 114, 115 and/or 116.

The primary and secondary sensor systems are connected together, for example through a serial RS232 connection, so that the measurement and control unit 117 obtains a continuous signal from the Doppler sensor 220. The continuous signal provides a measure of vehicle speed, and is in the form of a frequency difference signal as described above. In practice the frequency difference is about 300 Hertz for every 1 mile per hour of vehicle speed and drops to either a steady “on” or “off” when no vehicle is being sensed or when a vehicle in the beam is stationary.

The measurement and control unit 117 continually monitors the passage of vehicles passing over the loop sensors. It also continuously checks for a situation in which there have been no vehicles detected by any of the loop sensors 101-108 for a short period, typically one second. The next vehicle to arrive over the leading edge of any lane leading loop then causes the measurement and control unit 117 to trigger the taking of a reading from the Doppler sensor 220 at that instant.

Now the measurement and control unit 117 waits for another period, again typically one second, and if no other vehicle is detected by the loop system, deduces that it has observed a single vehicle sample, free from any other vehicles. In these circumstances, given the range and size of the vehicle as determined by the loop sensor, it can be stated with confidence that the reading from the radar system will be both accurate and reliable.

FIG. 3 shows this situation. There is only one vehicle 315 in the beam of the microwave as it crosses the loop sensor 102, and this single vehicle must therefore be responsible for both the loop sensor 102 actuation and the microwave Doppler reading. The readings are synchronised so that the measurement taken by the Doppler sensor 202 is at the moment the vehicle 315 enters the loop sensor 106. The exact position of the vehicle is known as it enters the loop sensor 106, so the cosine effect at the Doppler sensor 220 can be calculated from the distance and direction from the Doppler sensor 220 to the loop sensor 102.

Therefore, for this vehicle, the secondary sensor may be used as a reference for the primary sensor system. For example, assume that the loop sensors 102, 106 measure a speed of 56.8 mph for the vehicle, and the Doppler sensor 220 measures a speed of 56.5 mph. Since only a single vehicle is present in the beam the Doppler microwave can be used as the reference after adjustment for the cosine effect as described later, and it can be assessed that for this vehicle and other vehicles in the same lane the speed is over estimated by 0.3 mph.

The use of a microwave Doppler sensor as a secondary detector allows the sensor to be used with much greater accuracy than is normally the case with such a sensor, because it overcomes the two main difficulties with a stand-alone radar device when used for the accurate determination of speed, i.e. the synchronisation problem and the cosine effect.

The synchronisation problem is eliminated with the primary and secondary sensor working together because the reading is triggered to be taken at the precise moment when the vehicle speed is also being detected by the loop sensor. This is important, since if the driver of the vehicle sees the primary or secondary sensors, the equipment housing, and operators or hears a CB radio warning, he may suddenly take driving actions which cause the vehicle to be in a dynamic rather than steady state as he passes the general area of the site. If for example, he slows down by putting his foot on the brake pedal, or even releases his foot from the accelerator, the vehicle will assume a de-acceleration, which would result in incorrect error assessment of the primary sensor if the time of the secondary reading is either before or after that of the primary sensors.

In addition, the cosine effect can be precisely compensated, since the relative locations of the sensing elements is known, i.e. the Doppler microwave sensor, X, Y and Z in relation to each loop sensor in each lane. Thus the determination of the adjustment to be applied to the microwave sensor can be calculated in a three dimensional trigonometry exercise, to calculate the increase in the reading to compensate for the fact that the vehicle is heading in a direction at a net angle to the line from the microwave emitter to the front of the vehicle whose speed is being measured.

After a period of operation, the above situation will have occurred sufficiently often for a time series of errors in the loop system to be determined. As an example, a one hour test was performed for a system required to detect all speeds in kilometres per hour to within ±1%. The following error data was recorded:

| | Doppler | | Absolute | |
|---|---|---|---|---|
| Passing | Microwave Speed | Loop Speed | Error | |
| Vehicle | Report (km h⁻¹) | Report (km h⁻¹) | (km h⁻¹) | Error (%) |
| 1 | 147.2 | 147.5 | +0.3 | +0.20% |
| 2 | 95.7 | 95.5 | −0.2 | −0.21% |
| 3 | 101.0 | 101.5 | +0.5 | +0.50% |
| 4 | 97.3 | 97.5 | +0.2 | +0.21% |
| 5 | 147.9 | 147.5 | −0.4 | −0.27% |
| 6 | 95.5 | 95.5 | +0.0 | +0.00% |
| Average | | Mean | +0.067 | +0.072% |
| | | SD | 0.300 | 0.260% |

The statistics for the percentage error column are calculated: the mean speed error for the sample set was +0.072% while the standard deviation (SD) was 0.260%.

From this the average error for all vehicles can be calculated using Student's t from the standard statistical tables for six samples:

$${CI ( Average )}_{95 \%} = \pm {t}_{95 , n} \times \frac{SD}{\sqrt{n}} = 2.57 \times \frac{0.26 \%}{\sqrt{6}} = \pm 0.27 \%$$

Thus the true mean speed for all vehicles will be between (+0.07% −0.27%) and (+0.07% +0.27%), i.e. between −0.20% and +0.33%, of the mean speed reported by the loop system, calculated with a confidence level of 95%. If the accuracy requirement for the loop based system was ±1%, the station would be verified to meet the performance requirement, since the entire confidence interval of the mean speed is contained within the stated accuracy requirement.

Thus a reliable verification of the performance of the primary sensor system has been ascertained, also providing data about the measurement accuracy about all vehicles (i.e. mean speed) and systematic bias. This information has been gathered in a safer and more accurate method and at lower cost than the existing methods.

In the book, Quality Control Handbook by Juran, Gryna and Bingham (McGraw-Hill 1974), Juran et al describes a method of process control by statistical methods (Section 23). In summary, the output from a machine is sampled and certain key parameters measured for their conformity or value against the desired quality. The deviation is plotted over time, and whilst the readings lie within a certain distance of the mean, such distance being assessed from previous readings, the process (or the machine) is said to be in control.

It follows that when a significant change occurs in either the mean or the variation about the mean over time, that there has been a significant change in the characteristics of the machine, or “the underlying process”. This might occur, for example, if the machine has developed a fault. A method commonly employed is to plot a “control chart”, such as shown in FIG. 4. In FIG. 4a, a process measurement 401 is plotted as trace against time. Two horizontal lines 402, 403 show a calculated upper and lower limit, whose values have been calculated by taking the mean value of the process measurement 401 and adding and subtracting three times the standard deviation, (also known as “three-sigma” or three times the standard deviation).

The process is said to be in control whilst the periodic sampling of errors lie within these upper and lower bounds 402, 403.

These principles can be applied to the art of data collection. In this case, the principles apply to the periodic examination of the performance of the primary sensor by the secondary sensor. The secondary sensor is used as a reference to assess the error from the primary sensor by making an independent assessment of the parameter(s) in question. The error samples are monitored over time in the same way that the deviation of the output in relation to the desired value was plotted in the case of the production machine as shown in FIG. 4a.

Thus by periodically monitoring the variation in the difference in output between the primary and secondary sensors, the health of the underlying process in the primary sensors can be monitored. This makes it possible for this ongoing automatic verification to continue automatically and not involve staff at the site. During normal operation the measurement process can be said to be in control whilst the error during a periodic assessment by the secondary sensors is less than three times the historic standard deviation. If readings fall outside this range the primary sensor would be scheduled for a manual check since clearly something has changed.

A further extension of this methodology as applied to measurement systems is when a fundamental change occurs in the underlying process of sensing and measuring. When such a change occurs, either improving or degrading the process, a step change will be seen in the error plot, as shown for example in FIG. 4b. At the point 404 near the centre of this graph, some new factor has become effective and a step change has occurred, reducing the error to a new level which is about half the previous level. Of course in normal situations one would not expect to see a sudden unexplained improvement in measurement in which the error decreases. More typically, a fault in the equipment, for example water ingress into a loop or piezo sensor, or the complete failure of one of the sensors, would cause a step change in which the error increases. In either case, if a reasonable cause cannot be surmised, then a visit to the equipment site will be desirable to ascertain what has changed, possibly with a spare unit so that a substitution can be made.

Although this approach to statistical process control is well known and understood in application to factory production and the service industry, it has not been applied in the field of automatic data collection. The ideas of data fusion are now used, not to increase the number of parameters that can be observed (as described above with reference to loop and piezo sensors), but to control and to understand if there has been a shift in the underlying process in the primary sensing system.

The method described above accommodates speed verification where the primary sensors are speed loops and the secondary sensor is a microwave Doppler sensor. It will be appreciated that the method is thus well suited to the problem of verification of variable data such as vehicle speed. In addition, the same principles can also be applied to the validation of attribute data, for example to validate the performance of a loop based vehicle counter.

Video image processing is well known for vehicle detection and counting. For example in the 1987 publication “The ARRB Vehicle Detector”, J Dods describes the principles of video detection. Later the ARRB manufactured and marketed a product called CAMDAS which provided vehicle counts and speeds from a video camera signal. Also in 1987, Hoose and Willumsen published a technical paper entitled “Automatically extracting traffic data from video-tape using the CLIP4 parallel processor”. In 1993 the European Research Project DRIVE described 4 different video image processing systems for traffic monitoring (DRIVE Project V2022 Deliverable No. 7.1 (WP100)).

Whilst video image processing systems which have the characteristics described in the above references and currently in the market today are well suited to counting, they are not yet as accurate as loop detectors when accuracy is evaluated over 24 hours a day, 7 days a week, month in and month out. Dependant on conditions, counting accuracy may be worse than +/−20% error. But in very good conditions, for example with clear weather, uncongested traffic and a downward looking camera during say 10 am to 4 pm; the video detector accuracy will approach 100%. Video sensors are thus ideal as secondary sensors when loop sensors are used as primary sensors for vehicle counting.

By way of an example, a central computer can be linked to a Traffic Management Centre (TMS) using a fibre optic cable. An Instation at the TMS can be configured to simultaneously collect data from the on-site primary loop sensor system and analyse the vehicle flow using video image processing detection on the video stream. The video detector will thus analyse the incoming video signal, and extract features which enable each vehicle to be detected and counted in real time. The CCTV images are analysed only at times and in traffic conditions when they are known to produce accurate results, so it is necessary to determine the conditions during which period the output from the video image processing system can be used as a reference. For example, this control could be a simple time clock (so that CCTV detectors are only used during certain daylight hours) or a sunshine detector (perhaps derived from a contrast or brightness analysis of the CCTV signal). In addition this could be compared with a method of determining when only a single vehicle is in the video image processing or loop detector measurement zone. Clearly the video image processing could also occur at the roadside rather than at the TMS as described here.

In other words, the methodology can be applied to vehicle variables (e.g. speed) or vehicle attributes (e.g. vehicle count) using different technologies or sensors with different characteristics.

It is also possible to reverse the technologies used in the examples above.

For example, a Doppler microwave detector could be placed centrally on a gantry surveying three lanes of a motorway to act as the primary sensor. A pair of loop sensors could be placed in one of the lanes of the motorway, preferably the middle lane, to act as the secondary sensor. Because the microwave sensor is mounted at a height, the cosine effect dominates the error given by the Doppler sensor. In order to overcome this, rather than calculating the theoretical cosine effect, the Doppler sensor is calibrated by comparing the speed of a vehicle as measured by the Doppler sensor with the speed as measured by the loop sensor. The comparison is made only if there is a single vehicle in the microwave beam emitted by the Doppler sensor. This can be established by a frequency domain analysis of the return Doppler shifted signal to the microwave detector. Multiple vehicles will have differing speeds and be detected as multiple return frequencies.

After the calibration process is performed, which once determined should not alter if the geometry does not alter, the secondary loop sensor can take the role of verification sensor for all three lanes. This takes advantage of the fact that the distance to the vehicle in each lane from the Doppler sensor is very similar, and therefore any sensor drift or fault is just as likely to be detected in any lane, each lane having the same characteristics to the microwave beam. Clearly, in this application, the secondary sensor should be situated as close as possible to the central area of the beam, where the strongest signals are returned to the microwave receiver for Doppler detection.

The primary or secondary sensing system may have multiple zones of detection or have the ability to track multiple vehicles simultaneously though an overall zone of detection. Examples of such detectors include video image processing systems which can “hold” and track a number of vehicles through the field of view, and intelligent microwave or radar detectors which can detect multiple targets in the beam. In this case each detection zone within the detector may be treated as a single detector, and designated as primary or secondary sensor for the purpose of verification. The principles described above may then be applied to each zone detector of the multiple zone detector system.

It will also be appreciated that the principles of the invention may be applied to the detection of vehicle paths through an area or between different locations for example the so-called “origin-destination” (OD) surveys. For example, there are two well known methods of performing OD surveys: using number plate readers and using wide area video image processing to track vehicles from an entry point to an exit point. The former method works well with clear number plates and in free flowing traffic, but has difficulty with foreign plates and certain digit combinations The second method (image tracking) works well during the day but badly at night. Therefore each system can be programmed to be aware of the times that it is reliable and may be used as the secondary assessment system. In this example the two systems will alternate, the first system verifying the second system at certain times, with the second system verifying the first at other times.

It will be appreciated that departures from the above described embodiments may still fall within the scope of the invention. For example, the detection of suitable conditions for accurate operation of the secondary sensor may be undertaken by an entirely separate detection mechanism, such as for example a light sensor or a rain sensor. It will also be appreciated that although the examples above generally refer to microwave Doppler sensors, they will equally well apply to Doppler sensors using other forms or radiation, for example optical, electromagnetic or acoustic emissions. Indeed, a Doppler sensor (or loop sensor) need not be used at all. Any combination of sensors which allow the independent measurement of a vehicle parameter at the same time so that one can verify the other may be used.

The process of selecting suitable sensors is not mechanical, but relies on the practitioner having a good knowledge of the various sensors which can be used to detect the parameters or events in question, the commercial aspects of each, issues of mounting and positioning (which in the case of motorway gantries can be very significant in terms of cost), and how the characteristics of each sensor vary according to the ambient conditions. If a tertiary sensor or external source of knowledge is to be used to detect the ambient conditions, this too needs to be characterised.

It will be appreciated that the principles described above need not be limited to the field of highway traffic data collection, but may equally well apply, for example, to the process and control industry.

For example, consider the situation of measuring the temperature in a furnace on a continuous basis. A transducer for this purpose will of necessity be continuously exposed to a very hostile environment and will be designed not only to provide data but also to survive continuous exposure to this arduous environment.

Another technology which is used for temperature measurement is an infrared temperature measuring device which works by analysing the wavelength of emitted energy from high temperature bodies. Because it measures a wavelength, it is very accurate, but will not survive being placed inside a furnace. These two systems may therefore be used as primary and secondary sensors in a similar manner to the loop sensor and Doppler sensor of a Traffic Monitoring Station.

This may be implemented by connecting the two temperature measurement systems to a processor unit and a switch from the door of the furnace. When the furnace door is opened, the switch operates, indicating to the controller that the measurement from the infra-red probe (secondary sensor) is now accurate and may be used as a reference. A number of samples may be taken each time the furnace door is in the open condition. The furnace transducer (primary sensor) is thus verified using the principles described above and any fundamental change in the furnace transducer performance may be detected automatically by the processor unit as also described above.

1. A roadside traffic monitoring system, comprising:
a primary sensor for measuring a parameter of vehicles passing a measurement point;
a secondary sensor for measuring the same parameter of vehicles as they pass the measurement point, the secondary sensor able to measure the parameter to a higher level of accuracy than the primary sensor under predetermined conditions;
a conditions sensor for determining when the predetermined conditions are met; and
verification means for comparing the parameter as measured by the primary sensor with the parameter as measured by the secondary sensor if the predetermined conditions are met.

2. A roadside traffic monitoring system as claimed in claim 1, further comprising synchronisation means for ensuring that the parameter as measured by the primary sensor and the parameter as measured by the secondary sensor are measured at the same moment in time.

3. A roadside traffic monitoring system as claimed in claim 1, wherein the conditions sensor is included in the primary sensor or the secondary sensor.

4. A roadside traffic monitoring system as claimed in claim 1, wherein the primary sensor comprises a loop sensor.

5. A roadside traffic monitoring system as claimed in claim 1, wherein the primary sensor comprises a video detection system.

6. A roadside traffic monitoring system as claimed in claim 1, wherein the secondary sensor comprises a video detection system.

7. A roadside traffic monitoring system as claimed in claim 1, wherein the measured parameter is the speed of vehicles passing the measurement point.

8. A roadside traffic monitoring system as claimed in claim 7, wherein the secondary sensor comprises a radar device for measuring the Doppler shift caused by approaching vehicles.

9. A roadside traffic monitoring system as claimed in claim 8, wherein the distance and direction from the radar device to the measurement point is known so that errors in the radar device reading caused by the cosine effect can be accounted for.

10. A roadside measuring system as claimed in claim 8, wherein the predetermined conditions are met if:
a single vehicle passes the measurement point with at least a predetermined time before and after the passage of said single vehicle during which no other vehicles pass the measurement point.

11. A roadside traffic monitoring system as claimed in claim 10, wherein the predetermined time is about one second.

12. A roadside traffic monitoring system as claimed in claim 1, wherein the measured parameter is vehicle density or number.

13. A roadside traffic monitoring system as claimed in claim 1, arranged to determine an uncertainty in the primary sensor from a comparison of the parameter as measured by the secondary sensor with the parameter as measured by the primary sensor.

14. A roadside traffic monitoring system as claimed in claim 13, arranged so that the uncertainty in the primary sensor is determined from a series of comparisons of the parameter as measured by the secondary sensor with the parameter as measured by the primary sensor.

15. A roadside traffic monitoring system as claimed in claim 13, wherein the uncertainty in measurements made by the secondary sensor is known and is used to weight the significance of assessments of the uncertainty of the primary sensor.

16. A roadside traffic monitoring system as claimed in claim 13, arranged to alert an operator, if the uncertainty changes more than a predetermined amount.

17. A roadside traffic monitoring system as claimed in claim 13, arranged to monitor the standard deviation of the uncertainty of the primary sensor and compare it with a predetermined value.

18. A roadside traffic monitoring system as claimed in claim 17, arranged to alert an operator if the standard deviation deviates from the predetermined value by more than a predetermined amount.

19. A roadside traffic monitoring system as claimed in claim 12, arranged so that the primary sensor is recalibrated in response to a difference between the parameter as measured by the secondary sensor and the parameter as measured by the primary sensor if the predetermined conditions are met.

20. A roadside traffic monitoring system as claimed in claim 1, wherein the roles of the primary and secondary sensors are reversible so that the primary sensor is usable to calibrate the secondary sensor.

21. Apparatus for assessing the accuracy of a roadside traffic measurement station (TMS) having a primary sensor for measuring a parameter of vehicles passing a predetermined measurement point and the moment in time at which each vehicle passes the measurement point, the apparatus comprising:
a secondary sensor arranged to record the same parameter of vehicles as they pass the predetermined measurement point, the second parameter sensor being more accurate than the first parameter sensor if predetermined conditions are met;
condition measurement means for determining when said predetermined conditions are met; and
verification means for comparing the parameter as measured by the secondary parameter measurement means when the predetermined conditions are met with the parameter as measured by the primary parameter measurement means.

22. A method of monitoring a parameter of vehicles, comprising:
measuring the parameter of a vehicle at a measurement point using a primary sensor;
determining whether predefined conditions are met;
measuring the parameter of the vehicle at the measurement point using a secondary sensor, the secondary sensor being more accurate than the primary sensor if the predefined conditions are met; and
if the predefined conditions are met, using the difference between the parameter as measured by the secondary sensor and the parameter as measured by the primary sensor to determine an uncertainty in the measurement of the primary sensor.

23. A point speed measurement system, comprising:
a Doppler-effect speed sensor; and
a vehicle detection system arranged to trigger the Doppler-effect speed sensor when a vehicle is at a predetermined measurement position, the distance and direction from the Doppler-effect speed sensor to the predetermined measurement point being known;
arranged so that the output from the Doppler-effect speed sensor is adjusted to compensate for the cosine effect at the predetermined measurement position.

24. A data sensing system, comprising:
a primary sensor for measuring a parameter value;
a secondary sensor for measuring the same parameter value as the primary sensor, the secondary sensor able to measure the parameter value more reliably than the primary sensor under predetermined conditions;
a conditions sensor for determining when the predetermined conditions are met;
synchronization means for ensuring that the primary sensor and secondary sensor measure the parameter value at the same time; and
validation means for comparing the parameter value as measured by the primary sensor with the parameter value as measured by the secondary sensor if the predetermined conditions are met.

25. A method of validating a primary data sensor, comprising:
measuring a parameter with the primary sensor;
measuring the same parameter with a secondary sensor, the secondary sensor being more accurate than the primary sensor under predefined conditions;
determining whether the predefined conditions have been met; and
comparing the parameter as measured by the primary sensor with the parameter as measured by the secondary sensor if the predefined conditions are met.
